(19) United States
(12) Patent Application Publication
(10) Pub. No.: US 2024/0073026 A1
(43) Pub. Date: Feb. 29, 2024

(54) SYSTEM AND METHOD FOR PARTITIONING DIGITAL RESOURCES USING A NETWORKED RESOURCE PLATFORM

(71) Applicant: BANK OF AMERICA CORPORATION, Charlotte, NC (US)

(72) Inventors: George Anthony Albero, Charlotte, NC (US); Maharaj Mukherjee, Poughkeepsie, NY (US); Olivia Riley Sommer, Charlotte, NC (US); Elijah Clark, Charlotte, NC (US)

(73) Assignee: BANK OF AMERICA CORPORATION, Charlotte, NC (US)

(21) Appl. No.: 17/894,779

(22) Filed: Aug. 24, 2022

(51) Int. Cl. H04L 9/32; H04L 9/40

(52) U.S. Cl. CPC H04L 9/3239; H04L 63/0428

(57) ABSTRACT

A system is provided for partitioning digital resources using a networked resource platform. In particular, the system may generate digital resources using a customized set of executable code such that each digital resource may comprise one or more digital resource partitions. Each digital resource share may be associated with a cryptographic address. Upon receiving a request from a user to transfer the digital resource partitions, the system may execute various validation checks on the cryptographic address and the digital resource before executing the transfer. In this way, the system provides an efficient way to partition and transfer digital resources.

### FIELD OF THE INVENTION

The present invention embraces a system for partitioning digital resources using a networked resource platform.

### BACKGROUND

There is a need for an efficient and secure way to partition digital resources.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for partitioning digital resources using a networked resource platform. In particular, the system may generate digital resources using a customized set of executable code such that each digital resource may comprise one or more digital resource partitions. Each digital resource share may be associated with a cryptographic address. Upon receiving a request from a user to transfer the digital resource partitions, the system may execute various validation checks on the cryptographic address and the digital resource before executing the transfer. In this way, the system provides an efficient way to partition and transfer digital resources.

Accordingly, embodiments of the present disclosure provide a system for partitioning digital resources using a networked resource platform, the system comprising at least one non-transitory storage device; and at least one processor coupled to the at least one non-transitory storage device, wherein the at least one processor is configured to generate, using a custom set of executable code, a digital resource comprising one or more digital resource partitions; present a graphical interface of a networked resource platform on a display device of a first endpoint device; receive, from the first endpoint device through the networked resource platform, a request to transfer a portion of the one or more digital resource partitions to a cryptographic address associated with the first endpoint device; execute one or more validation checks on the cryptographic address and the portion of the one or more digital resource partitions; and based on executing the one or more validation checks, transfer the portion of the one or more digital resource partitions to the cryptographic address associated with the first endpoint device.

In some embodiments, generating the digital resource comprises executing a duplicate check on the digital resource, wherein executing the duplicate check comprises retrieving a copy of a digital object associated with the digital resource from an object address within the custom set of executable code; generating a hash output value by inputting the copy of the digital object into a hash algorithm; and comparing the hash output value with one or more authentication hash values within an authentication repository.

In some embodiments, comparing the hash output value with the one or more authentication hash values comprises detecting a match between the hash output value and an authentication hash value of the one or more authentication hash values within the authentication repository; and determining that the digital object has already been used to generate an existing digital resource.

In some embodiments, comparing the hash output value with the one or more authentication hash values comprises detecting no match between the hash output value and an authentication hash value of the one or more authentication hash values within the authentication repository; determining that the digital object has not been used to generate an existing digital resource; and adding the hash output value to the authentication repository.

In some embodiments, transferring the portion of the one or more digital resource partitions to the cryptographic address associated with the first endpoint device comprises setting an ownership parameter value for each of the digital resource partitions within the portion of the one or more digital resource partitions to the cryptographic address associated with the first endpoint device.

In some embodiments, the one or more validation checks comprises verifying an amount of alternate resources associated with the cryptographic address.

In some embodiments, the digital resource is a non-fungible token.

Embodiments of the present disclosure also provide a computer program product for partitioning digital resources using a networked resource platform, the computer program product comprising a non-transitory computer-readable medium comprising code causing an apparatus to generate, using a custom set of executable code, a digital resource comprising one or more digital resource partitions; present a graphical interface of a networked resource platform on a display device of a first endpoint device; receive, from the first endpoint device through the networked resource platform, a request to transfer a portion of the one or more digital resource partitions to a cryptographic address associated with the first endpoint device; execute one or more validation checks on the cryptographic address and the portion of the one or more digital resource partitions; and based on executing the one or more validation checks, transfer the portion of the one or more digital resource partitions to the cryptographic address associated with the first endpoint device.

In some embodiments, generating the digital resource comprises executing a duplicate check on the digital resource, wherein executing the duplicate check comprises retrieving a copy of a digital object associated with the digital resource from an object address within the custom set of executable code; generating a hash output value by inputting the copy of the digital object into a hash algorithm; and comparing the hash output value with one or more authentication hash values within an authentication repository.

In some embodiments, comparing the hash output value with the one or more authentication hash values comprises detecting a match between the hash output value and an authentication hash value of the one or more authentication hash values within the authentication repository; and determining that the digital object has already been used to generate an existing digital resource.

In some embodiments, comparing the hash output value with the one or more authentication hash values comprises detecting no match between the hash output value and an authentication hash value of the one or more authentication hash values within the authentication repository; determining that the digital object has not been used to generate an existing digital resource; and adding the hash output value to the authentication repository.

In some embodiments, transferring the portion of the one or more digital resource partitions to the cryptographic address associated with the first endpoint device comprises setting an ownership parameter value for each of the digital resource partitions within the portion of the one or more digital resource partitions to the cryptographic address associated with the first endpoint device.

In some embodiments, the one or more validation checks comprises verifying an amount of alternate resources associated with the cryptographic address.

Embodiments of the present disclosure also provide a computer-implemented method for partitioning digital resources using a networked resource platform, the computer-implemented method comprising generating, using a custom set of executable code, a digital resource comprising one or more digital resource partitions; presenting a graphical interface of a networked resource platform on a display device of a first endpoint device; receiving, from the first endpoint device through the networked resource platform, a request to transfer a portion of the one or more digital resource partitions to a cryptographic address associated with the first endpoint device; executing one or more validation checks on the cryptographic address and the portion of the one or more digital resource partitions; and based on executing the one or more validation checks, transferring the portion of the one or more digital resource partitions to the cryptographic address associated with the first endpoint device.

In some embodiments, generating the digital resource comprises executing a duplicate check on the digital resource, wherein executing the duplicate check comprises retrieving a copy of a digital object associated with the digital resource from an object address within the custom set of executable code; generating a hash output value by inputting the copy of the digital object into a hash algorithm; and comparing the hash output value with one or more authentication hash values within an authentication repository.

In some embodiments, comparing the hash output value with the one or more authentication hash values comprises detecting a match between the hash output value and an authentication hash value of the one or more authentication hash values within the authentication repository; and determining that the digital object has already been used to generate an existing digital resource.

In some embodiments, comparing the hash output value with the one or more authentication hash values comprises detecting no match between the hash output value and an authentication hash value of the one or more authentication hash values within the authentication repository; determining that the digital object has not been used to generate an existing digital resource; and adding the hash output value to the authentication repository.

In some embodiments, transferring the portion of the one or more digital resource partitions to the cryptographic address associated with the first endpoint device comprises setting an ownership parameter value for each of the digital resource partitions within the portion of the one or more digital resource partitions to the cryptographic address associated with the first endpoint device.

In some embodiments, the one or more validation checks comprises verifying an amount of alternate resources associated with the cryptographic address.

In some embodiments, the digital resource is a non-fungible token.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for the system for partitioning digital resources using a networked resource platform, in accordance with an embodiment of the present disclosure;

FIG. 2A illustrates an exemplary DLT architecture, in accordance with an embodiment of the present disclosure;

FIG. 2B illustrates an exemplary transaction object, in accordance with an embodiment of the present disclosure;

FIG. 3A illustrates an exemplary process of creating an NFT 300, in accordance with an embodiment of the present disclosure; and

FIG. 3B illustrates an exemplary NFT 304 as a multi-layered documentation of a resource, in accordance with an embodiment of the present disclosure; and

FIG. 4 illustrates a process flow for partitioning digital resources using a networked resource platform, in accordance with an embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “computing resource” or “resource” may generally refer to physical and/or virtual components or materials that are used in the operation of a computing device. Accordingly, examples of such resources may include processing power, memory allocation, cache space, storage space, data files, network connections and/or bandwidth, electrical power, input/output functions, and the like. Resources stored in a digital format (e.g., data records) may be referred to as “digital resources.”

“Cryptographic function” or “cryptographic algorithm” as used herein may refer to a set of logical and/or mathematical operations or processes that may be executed on a specified segment of data to produce a cryptographic output (or “cypher”). In some embodiments, the cryptographic algorithm may be an algorithm such as Rivest-Shamir-Adleman (“RSA”), Shamir's Secret Sharing (“SSS”), or the like. In other embodiments, the cryptographic algorithm may be a hash algorithm which may, given a specified data input, produce a cryptographic hash output value which is a fixed-length character string. Examples of such hash algorithms may include MD5, Secure Hash Algorithm/SHA, or the like. According, “hashing” or “hashed” as used herein may refer to the process of producing a hash output based on a data input into a hash algorithm.

As used herein, “non-fungible token” or “NFT” may be a digital resource which may be uniquely linked to a particular resource. An NFT may typically be stored on a distributed register that certifies ownership and authenticity of the resource, and exchangeable in a peer-to-peer network.

Digital resources such as NFTs may be stored within a network environment and used for a number of different purposes. For instance, NFTs may be created and uniquely associated with digital objects or items, electronically stored data, physical objects, and/or the like. When NFTs are minted using a set of executable code for generating the NFT (e.g., a smart contract), the smart contract may specify a cryptographic address (e.g., a hash value) to be designated as the owner of the NFT. That said, in some cases, it may be desirable to generate an NFT in which multiple cryptographic addresses are designated as having an ownership of the NFT.

In such embodiments, the system may provide a way to partition digital resources (e.g., NFTs). To this end, the system may comprise a customized smart contract that allows the system to designate one or more cryptographic addresses as partial owners of the NFT. In this regard, the smart contract may divide ownership of the NFT into one or more discrete digital resource partitions, where each digital resource share is associated with a designated amount of an alternate resource (e.g., a cryptocurrency). Accordingly, the smart contract may allow a cryptographic ownership address to be designated for each digital resource share. In some embodiments, the smart contract may further specify other parameters, which may include a minimum amount of alternate resource that is required to transfer ownership of particular a digital resource share, the number of digital resources partitions available for transfer, and/or the like.

In some embodiments, the one or more digital resource partitions may be associated with certain unique portions of the object associated with the NFT. For instance, if the object is a digital object such as an image file, certain portions of the image file (e.g., certain pixels) may uniquely be associated with specific digital resource partitions. In an exemplary embodiment, if a user wishes to obtain ownership of the specific portions of the image file (e.g., a 100 by 100-pixel square in the top-left corner), the user may (e.g., through a user computing device), access and execute the smart contract to transfer the requisite alternate resources associated with digital resources partitions associated with the portions of the image file to be obtained. Accordingly, certain digital resource partitions may be associated with a higher required amount of alternate resources to obtain ownership thereof.

The system may further comprise a networked resource platform that may be accessible by one or more users to acquire and/or transfer digital resource partitions. The networked resource platform may be accessed by one or more users using endpoint devices associated with each of the users (e.g., a desktop computer, smartphone, and/or the like). The network resource platform may comprise one or more entries, each of the entries being uniquely associated with an NFT generated using the customized smart contract. The entries may be displayed on a graphical user interface of the networked resource platform, where the graphical user interface comprises one or more interface elements configured to allow users to take certain actions with respect to the entries and the NFTs associated therewith. Each of the entries may comprise a current value of various digital resource partitions of the NFT (e.g., the amount of alternate resources needed to obtain or purchase the digital resource partitions). Accordingly, a user may log onto the networked resource platform using a cryptographic address associated with the user.

Each cryptographic address may be uniquely associated with a private key such that the private key may serve as proof of authorization of certain actions taken with respect to the cryptographic address (e.g., acquisition of digital resources and/or digital resource partitions). Accordingly, the user may submit a request to interact with the smart contract associated with a particular NFT through the networked resource platform, where the transaction comprises a selection by the user of one or more digital resource partitions. The system may then perform one or more validation checks on the request, which may include actions such as verifying that the cryptographic address is valid, that the address is associated with a required amount of alternate resources (e.g., an amount of cryptocurrency), that the selected digital resource partitions are eligible to be transferred, and other validation checks based on the smart contract, cryptographic address associated with the user, and other types of information. Once the validation checks have been completed, the system may execute the transfer of the digital resource partitions selected by the user to the cryptographic address associated with the user (e.g., by setting the “ownership” value of the digital resource partitions to the cryptographic address associated with the user).

Subsequently, the user may access the platform to transfer the digital resource partitions owned by the user to another user. In such embodiments, the user may submit a request to list the digital resource partitions on the networked resource platform. The system may perform a series of validation checks on the request, which may include verifying that the cryptographic address associated with the request is the owner of the digital resource partitions. In some embodiments, the validation checks may comprise authentication of the object associated with the digital resource. In this regard, the system may comprise an authentication repository, which in turn comprises one or more hash values used to authenticate digital objects. The system may execute a hash function on the digital object associated with the request to list the digital resource and subsequently compare the hash output value with the hash values within the authentication repository. If a match is found, the system may automatically reject the request to list the digital resource.

In an exemplary embodiment, a user may submit a request to list a digital resource (e.g., an NFT) and/or digital resource partitions which are associated with a digital image file. To verify that an NFT associated with the digital image file has not already been listed and/or created, the system may retrieve the digital image file from the address specified within the NFT and input the digital image file into a hash algorithm to obtain a hash output. The system may then compare the hash output with the values within the authentication repository. If a match is found, the system may determine that an NFT linked with the digital image has already been created, and thus subsequently reject a request to mint a new NFT referencing the same digital image. If, however, no match is found, the system may allow the request to be fulfilled.

Once the request has been validated, the system may display an indication on the graphical user interface that the digital resource partitions are available for transfer. A subsequent user may then log into the networked resource platform using a cryptographic address associated with the subsequent user to submit a transfer request to obtain the digital resource partitions. In this way, the system provides an efficient way to perform transfer of digital resources.

The present disclosure provides a technical solution to the technical problem of partitioning digital resources. Specifically, by using a custom smart contract with parameters to specify ownership of each digital resource share, the system allows users to efficiently associate fractional portions of a digital resource with certain cryptographic addresses. Furthermore, by performing hash-based verification of digital objects associated with the digital resources, the system may prevent the addition of duplicative digital resources to the distributed ledger, which in turn saves computing resources such as processing power, memory space, cache space, networking bandwidth, and/or the like.

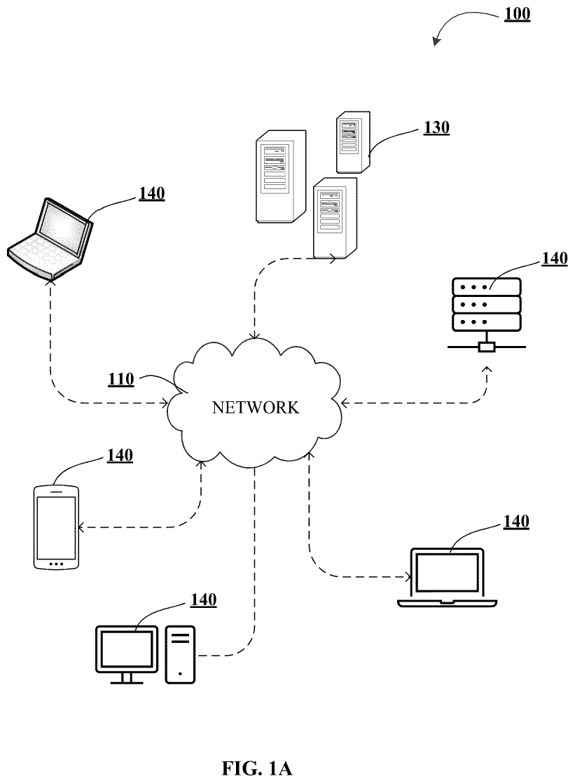

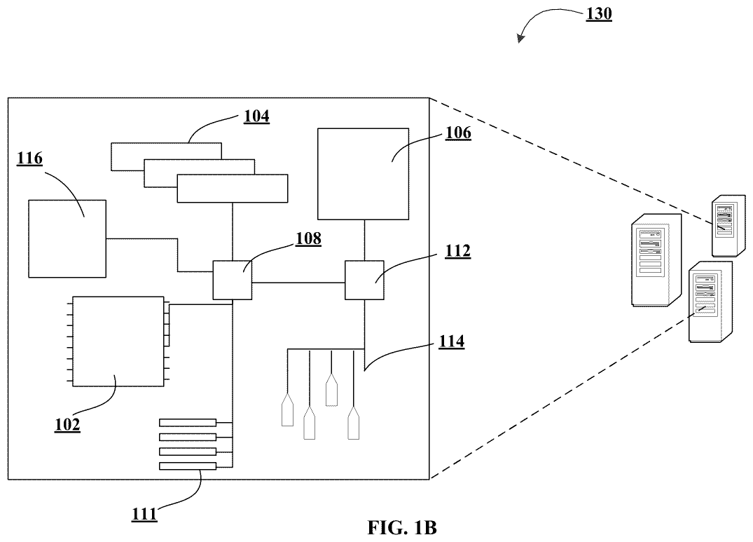

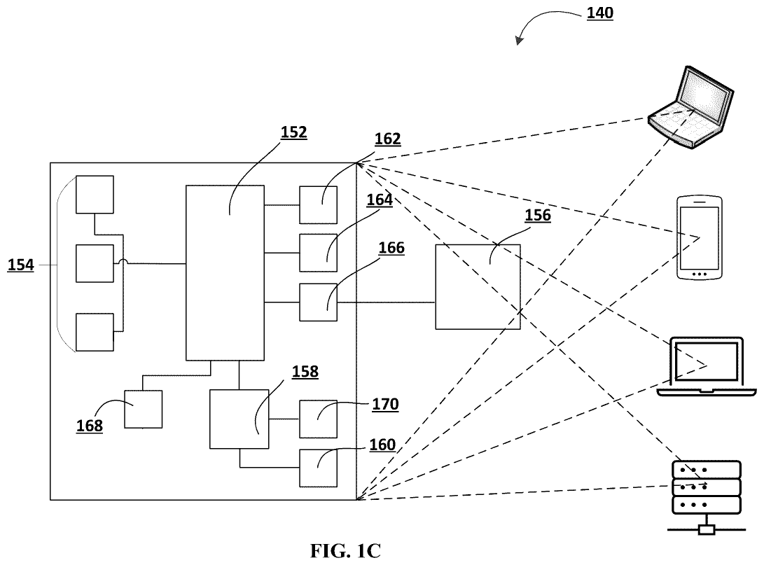

FIGS. 1A-1C illustrate technical components of an exemplary distributed computing environment 100 for the system for partitioning digital resources using a networked resource platform, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

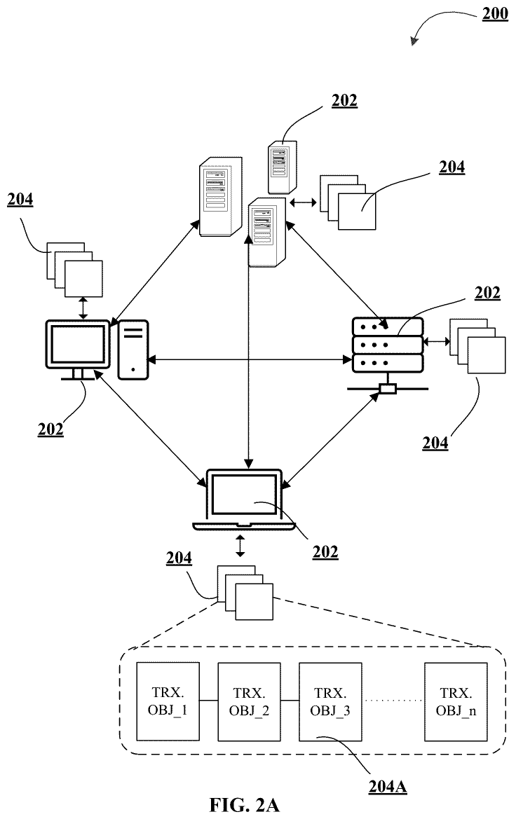

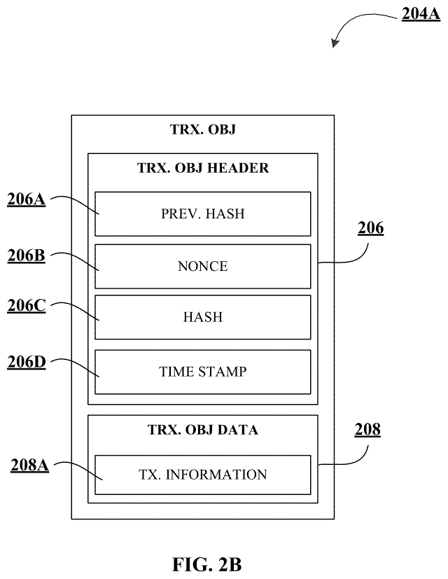

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger (which may also be referred to herein as a “distributed register”) of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B—a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

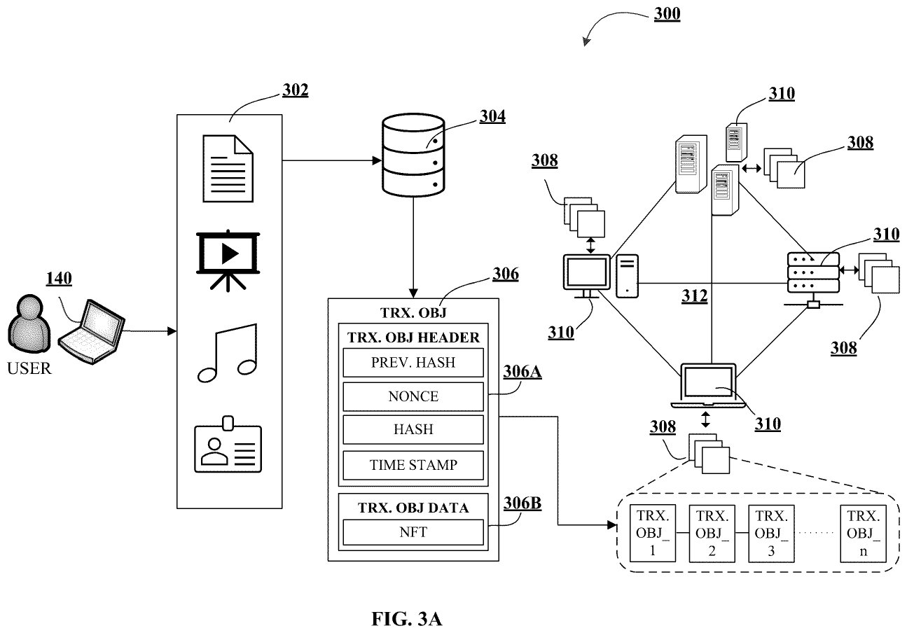

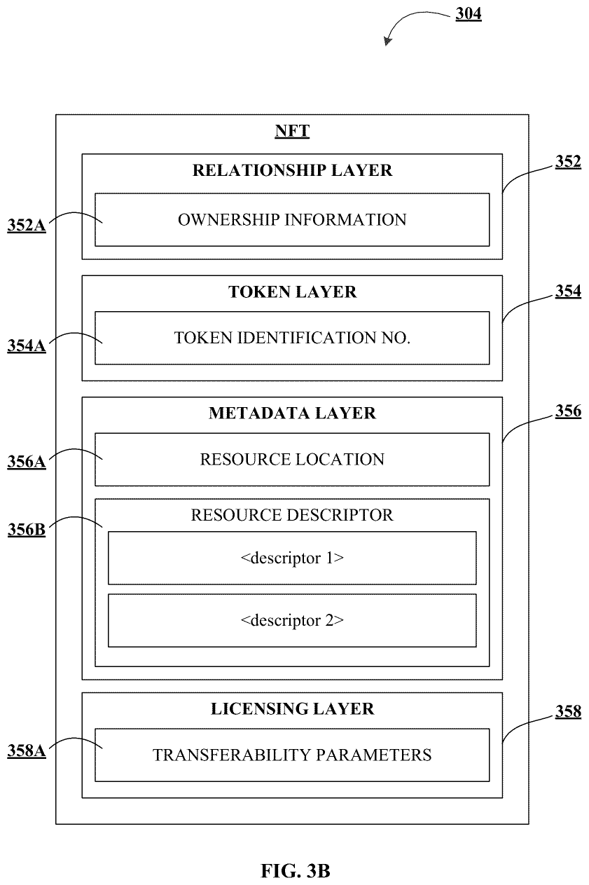

FIG. 3A illustrates an exemplary process of creating an NFT 300, in accordance with an embodiment of the invention. As shown in FIG. 3A, to create or “mint” an NFT, a user (e.g., NFT owner) may identify, using a user input device 140, resources 302 that the user wishes to mint as an NFT. Typically, NFTs are minted from digital objects that represent both tangible and intangible objects. These resources 302 may include a piece of art, music, collectible, videos, real-world items such as artwork and real estate, or any other presumed valuable object. These resources 302 are then digitized into a proper format to produce an NFT 304. The NFT 304 may be a multi-layered documentation that identifies the resources 302 but also evidences various transaction conditions associated therewith, as described in more detail with respect to FIG. 3A.

To record the NFT in a distributed ledger, a transaction object 306 for the NFT 304 is created. The transaction object 306 may include a transaction header 306A and a transaction object data 306B. The transaction header 306A may include a cryptographic hash of the previous transaction object, a nonce—a randomly generated 32-bit whole number when the transaction object is created, cryptographic hash of the current transaction object wedded to the nonce, and a time stamp. The transaction object data 306B may include the NFT 304 being recorded. Once the transaction object 306 is generated, the NFT 204 is considered signed and forever tied to its nonce and hash. Once generated, the transaction object 306 is then deployed in the distributed ledger 308. At this time, a distributed ledger address is generated for the transaction object 306, i.e., an indication of where it is located on the distributed ledger 308 and captured for recording purposes. Once deployed, the NFT 304 is linked permanently to its hash and the distributed ledger 308, and is considered recorded in the distributed ledger 308, thus concluding the minting process

As shown in FIG. 3A, the distributed ledger 308 may be maintained on multiple devices (nodes) 310 that are authorized to keep track of the distributed ledger 308. For example, these nodes 310 may be computing devices such as system 130 and client device(s) 130. One node 310 may have a complete or partial copy of the entire distributed ledger 308 or set of transactions and/or transaction objects on the distributed ledger 308. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 3B illustrates an exemplary NFT 304 as a multi-layered documentation of a resource, in accordance with an embodiment of an invention. As shown in FIG. 3B, the NFT may include at least relationship layer 352, a token layer 354, a metadata layer 356, and a licensing layer 358. The relationship layer 352 may include ownership information 352A, including a map of various users that are associated with the resource and/or the NFT 304, and their relationship to one another. For example, if the NFT 304 is purchased by buyer B1 from a seller S 1, the relationship between B1 and Si as a buyer-seller is recorded in the relationship layer 352. In another example, if the NFT 304 is owned by O1 and the resource itself is stored in a storage facility by storage provider SP1, then the relationship between O1 and SP1 as owner-file storage provider is recorded in the relationship layer 352. The token layer 354 may include a token identification number 354A that is used to identify the NFT 304. The metadata layer 356 may include at least a file location 356A and a file descriptor 356B. The file location 356A may provide information associated with the specific location of the resource 302. Depending on the conditions listed in the smart contract underlying the distributed ledger 308, the resource 302 may be stored on-chain, i.e., directly on the distributed ledger 308 along with the NFT 304, or off-chain, i.e., in an external storage location. The file location 356A identifies where the resource 302 is stored. The file descriptor 356B may include specific information associated with the source itself 302. For example, the file descriptor 356B may include information about the supply, authenticity, lineage, provenance of the resource 302. The licensing layer 358 may include any transferability parameters 358B associated with the NFT 304, such as restrictions and licensing rules associated with purchase, sale, and any other types of transfer of the resource 302 and/or the NFT 304 from one person to another. Those skilled in the art will appreciate that various additional layers and combinations of layers can be configured as needed without departing from the scope and spirit of the invention.

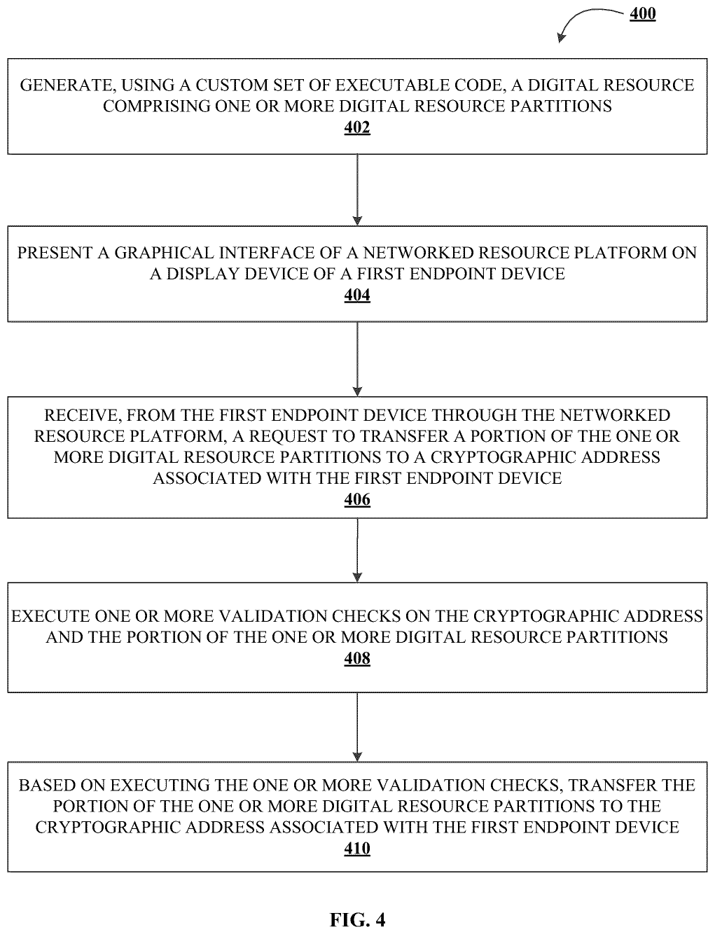

FIG. 4 illustrates a process flow 400 for partitioning digital resources using a networked resource platform, in accordance with an embodiment of the present disclosure. The process begins at block 402, where the system generates, using a custom set of executable code, a digital resource comprising one or more digital resource partitions. The digital resource may in turn be uniquely associated with an object. Accordingly, the custom set of executable code may be a smart contract for minting an NFT associated with a digital object such as a data file (e.g., an image file, video file, audio file, website or webpage, text data, application data, and/or the like). The NFT may be divided into the various digital resource partitions, where the smart contract specifies an ownership parameter for each digital resource share. The ownership parameter may be, for instance, a cryptographic hash value representing a cryptographic address associated with a user and/or endpoint device. In this way, the system allows multiple cryptographic addresses to be associated with portions or fractions of the minted NFT, and may further allow such portions or fractions to be transferred to other cryptographic addresses.

In some embodiments, a subset or portion of the one or more digital resource partitions may be associated with a specified portion of the object associated with the NFT. For instance, if the object is an audio file, ownership of the portion of the one or more digital resource partitions may signify an ownership of a specific timeframe within the audio file (e.g., the first 10 seconds).

In some embodiments, the system may perform a duplicate check in which the system verifies whether the digital object associated with the NFT has already been used to generate or mint an NFT within the distributed ledger. To perform the duplicate check, the system may retrieve a copy of the digital object from the digital address specified within the smart contract of the NFT (e.g., a hyperlink to a data file stored on a networked server). The system may input the digital object into a hash algorithm to generate a hash output value of the digital object. The hash output value may then be compared to the authentication hash values within the authentication repository. If an exact match is found within the authentication repository, the system may determine that the digital object has already been used in creating a digital resource and subsequently block the digital resource from being generated. However, if no match is found, the system may proceed with the generation of the digital resource. The system may further store the hash output value in the authentication repository, thereby preventing the creation of subsequent NFTs referencing the same digital object.

The process continues to block 404, where the system presents a graphical interface of a networked resource platform on a display device of a first endpoint device. The networked resource platform may be accessible (e.g., via the Internet) by various endpoint devices for the purpose of transferring digital resources and/or digital resource partitions. Accordingly, an endpoint device may log onto the networked resource platform using a cryptographic address associated with the endpoint device. In one embodiment, the endpoint device may use a private key associated with the cryptographic address (e.g., to digitally sign a data record) to authenticate the endpoint device and/or cryptographic address while logging onto the networked resource platform.

The networked resource platform may present various interface elements for selecting digital resources and/or digital resource partitions to be transferred. In an exemplary embodiment, the networked resource platform may be a web-based server application that may be configured to display a listing of digital resources and/or digital resource partitions that are available to be transferred. Accordingly, upon the user selecting a digital resource and/or digital resource share, the system may provide various types of information regarding the digital resource and/or digital resource partitions, such as the amount of resources needed to execute the transfer with respect to a particular digital resource and/or digital resource share. Continuing the above-referenced example, a user may wish to purchase a portion of an NFT corresponding to a particular audio file (e.g., a digital song recording). The digital resource platform may display a description of the NFT and the audio file as well as a current price of each of the digital resource partitions available for transfer.

The process continues to block 406, where the system receives, from the first endpoint device through the networked resource platform, a request to transfer a portion of the one or more digital resource partitions to a cryptographic address associated with the first endpoint device. The request may be received from the endpoint device based on the user selecting the interface elements needed to initiate the transfer. In an exemplary embodiment, the user may provide a selection of the digital resource partitions to be purchased and interact with a “confirm” button presented within the graphical user interface. Accordingly, the request may specify the digital resource partitions to be purchased along with a recipient cryptographic address. Once the transfer is completed, the recipient cryptographic address may be associated with the digital resource partitions as the owner of the digital resource partitions.

The process continues to block 408, where the system executes one or more validation checks on the cryptographic address and the portion of the one or more digital resource partitions. The validation checks may comprise, for instance, verifying that an adequate amount of alternate resources are associated with the recipient cryptographic address, verifying that the cryptographic address is a valid address (e.g., that the address is the correct character length and does not contain invalid characters), and verifying that any other requirements of the smart contract have been satisfied.

The process continues to block 410, where the system based on executing the one or more validation checks, transfers the portion of the one or more digital resource partitions to the cryptographic address associated with the first endpoint device. In this regard, transferring the portion may comprise setting the ownership parameter associated with each of the digital resource partitions within the portion of the one or more digital resource partitions to the cryptographic address associated with the first endpoint device. Subsequent to the transfer, the portion of the digital resource partitions will be associated with the cryptographic address associated with the first endpoint device until the digital resource partitions are then transferred from the cryptographic address to a second cryptographic address. Accordingly, in some embodiments, the system may receive a request from the first endpoint device to list the portion of digital resource partitions on the networked resource platform. The system may verify that the portion of digital resource partitions are associated with the cryptographic address associated with the first endpoint device and subsequently generate an entry for the portion of digital resource partitions, where the entry may be presented on the graphical interface of the networked resource platform accessed by a second endpoint device. The second endpoint device may then submit a request to transfer the portion of digital resource partitions to a cryptographic address associated with the second endpoint device. In this way, the system provides a secure and efficient way to partition and transfer digital resources.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for partitioning digital resources using a networked resource platform, the system comprising:
at least one non-transitory storage device; and
at least one processor coupled to the at least one non-transitory storage device, wherein the at least one processor is configured to:
generate, using a custom set of executable code, a digital resource comprising one or more digital resource partitions;
present a graphical interface of a networked resource platform on a display device of a first endpoint device;
receive, from the first endpoint device through the networked resource platform, a request to transfer a portion of the one or more digital resource partitions to a cryptographic address associated with the first endpoint device;
execute one or more validation checks on the cryptographic address and the portion of the one or more digital resource partitions; and
based on executing the one or more validation checks, transfer the portion of the one or more digital resource partitions to the cryptographic address associated with the first endpoint device.

2. The system of claim 1, wherein generating the digital resource comprises executing a duplicate check on the digital resource, wherein executing the duplicate check comprises:
retrieving a copy of a digital object associated with the digital resource from an object address within the custom set of executable code;
generating a hash output value by inputting the copy of the digital object into a hash algorithm; and
comparing the hash output value with one or more authentication hash values within an authentication repository.

3. The system of claim 2, wherein comparing the hash output value with the one or more authentication hash values comprises:
detecting a match between the hash output value and an authentication hash value of the one or more authentication hash values within the authentication repository; and
determining that the digital object has already been used to generate an existing digital resource.

4. The system of claim 2, wherein comparing the hash output value with the one or more authentication hash values comprises:
detecting no match between the hash output value and an authentication hash value of the one or more authentication hash values within the authentication repository;
determining that the digital object has not been used to generate an existing digital resource; and
adding the hash output value to the authentication repository.

5. The system of claim 1, wherein transferring the portion of the one or more digital resource partitions to the cryptographic address associated with the first endpoint device comprises setting an ownership parameter value for each of the digital resource partitions within the portion of the one or more digital resource partitions to the cryptographic address associated with the first endpoint device.

6. The system of claim 1, wherein the one or more validation checks comprises verifying an amount of alternate resources associated with the cryptographic address.

7. The system of claim 1, wherein the digital resource is a non-fungible token.

8. A computer program product for partitioning digital resources using a networked resource platform, the computer program product comprising a non-transitory computer-readable medium comprising code causing an apparatus to:
generate, using a custom set of executable code, a digital resource comprising one or more digital resource partitions;
present a graphical interface of a networked resource platform on a display device of a first endpoint device;
receive, from the first endpoint device through the networked resource platform, a request to transfer a portion of the one or more digital resource partitions to a cryptographic address associated with the first endpoint device;
execute one or more validation checks on the cryptographic address and the portion of the one or more digital resource partitions; and
based on executing the one or more validation checks, transfer the portion of the one or more digital resource partitions to the cryptographic address associated with the first endpoint device.

9. The computer program product of claim 8, wherein generating the digital resource comprises executing a duplicate check on the digital resource, wherein executing the duplicate check comprises:
retrieving a copy of a digital object associated with the digital resource from an object address within the custom set of executable code;
generating a hash output value by inputting the copy of the digital object into a hash algorithm; and
comparing the hash output value with one or more authentication hash values within an authentication repository.

10. The computer program product of claim 9, wherein comparing the hash output value with the one or more authentication hash values comprises:
detecting a match between the hash output value and an authentication hash value of the one or more authentication hash values within the authentication repository; and
determining that the digital object has already been used to generate an existing digital resource.

11. The computer program product of claim 9, wherein comparing the hash output value with the one or more authentication hash values comprises:
detecting no match between the hash output value and an authentication hash value of the one or more authentication hash values within the authentication repository;
determining that the digital object has not been used to generate an existing digital resource; and
adding the hash output value to the authentication repository.

12. The computer program product of claim 8, wherein transferring the portion of the one or more digital resource partitions to the cryptographic address associated with the first endpoint device comprises setting an ownership parameter value for each of the digital resource partitions within the portion of the one or more digital resource partitions to the cryptographic address associated with the first endpoint device.

13. The computer program product of claim 8, wherein the one or more validation checks comprises verifying an amount of alternate resources associated with the cryptographic address.

14. A computer-implemented method for partitioning digital resources using a networked resource platform, the computer-implemented method comprising:
generating, using a custom set of executable code, a digital resource comprising one or more digital resource partitions;
presenting a graphical interface of a networked resource platform on a display device of a first endpoint device;
receiving, from the first endpoint device through the networked resource platform, a request to transfer a portion of the one or more digital resource partitions to a cryptographic address associated with the first endpoint device;
executing one or more validation checks on the cryptographic address and the portion of the one or more digital resource partitions; and
based on executing the one or more validation checks, transferring the portion of the one or more digital resource partitions to the cryptographic address associated with the first endpoint device.

15. The computer-implemented method of claim 14, wherein generating the digital resource comprises executing a duplicate check on the digital resource, wherein executing the duplicate check comprises:
retrieving a copy of a digital object associated with the digital resource from an object address within the custom set of executable code;
generating a hash output value by inputting the copy of the digital object into a hash algorithm; and
comparing the hash output value with one or more authentication hash values within an authentication repository.

16. The computer-implemented method of claim 15, wherein comparing the hash output value with the one or more authentication hash values comprises:
detecting a match between the hash output value and an authentication hash value of the one or more authentication hash values within the authentication repository; and
determining that the digital object has already been used to generate an existing digital resource.

17. The computer-implemented method of claim 15, wherein comparing the hash output value with the one or more authentication hash values comprises:
detecting no match between the hash output value and an authentication hash value of the one or more authentication hash values within the authentication repository;
determining that the digital object has not been used to generate an existing digital resource; and
adding the hash output value to the authentication repository.

18. The computer-implemented method of claim 14, wherein transferring the portion of the one or more digital resource partitions to the cryptographic address associated with the first endpoint device comprises setting an ownership parameter value for each of the digital resource partitions within the portion of the one or more digital resource partitions to the cryptographic address associated with the first endpoint device.

19. The computer-implemented method of claim 14, wherein the one or more validation checks comprises verifying an amount of alternate resources associated with the cryptographic address.

20. The computer-implemented method of claim 14, wherein the digital resource is a non-fungible token.
